(19) United States
(12) Patent Application Publication
(10) Pub. No.: US 2015/0278454 A1
(43) Pub. Date: Oct. 1, 2015

(54) Method and Apparatus for Managing Client's Medical Records in Mobile Terminal

(71) Applicant: Hyung Sik Choi, Seoul (KR)

(72) Inventor: Hyung Sik Choi, Seoul (KR)

(21) Appl. No.: 14/410,209

(22) PCT Filed: Dec. 28, 2012
(86) PCT No.: PCT/KR2012/011797

§ 371 Date: Dec. 22, 2014

(30) Foreign Application Priority Data
Dec. 10, 2012 (KR) 10-2012-0143026

(51) Int. Cl. G06F 19/00

(52) U.S. Cl. CPC G06F 19/323

(57) ABSTRACT

Methods and apparatus for managing a client's medical records in a mobile terminal of the client are provided. In communications between a personal computer (PC) of each of medical institutions or hospitals and a mobile terminal of the client, a client information manager registers client information including information about the client's mobile terminal, which client information is then stored and managed in a client information database (DB), in response to a client registration request from the client's mobile terminal to the PC; and a medical records manager compiles or converts the client's medical records in the PC, which complied or converted medical records are then transmitted to the client's mobile terminal, and stores and manages transmission information of the client's medical records in a transmission medical records DB. The client's medical records are managed by using a reader software program installed in the client's mobile terminal.

### TECHNICAL FIELD

The present invention relates to a method and apparatus for managing a client's medical records in a mobile terminal of the client, and more particularly, to a method and apparatus for managing client's medical records in a mobile terminal of the client, in which the client's medical records, in particular, medical video images of the client that are generated in medical institutions or hospitals, are stored and displayed in and on the client's mobile terminal.

### BACKGROUND ART

In the case of recently developed medical records management systems, medical records, in particular, medical video images that are generated in medical institutions or hospitals, are contained on a medium such as a compact disc (CD) and provided for a patient or a patient's agent that is called a client, and thus inconvenience may occur in that the client separately manages all CDs that contain the client's medical records and are received from medical institutions or hospitals. Since CDs may be formatted differently for respective medical institutions or hospitals, and thus respectively different viewers or readers are needed to view medical records such as medical video images contained in the respectively differently formatted CDs, it is not only inconvenient to keep and carry the CDs, but is also disadvantageous in that all the medical records such as the medical video images contained in the different CDs cannot be seen comprehensively in a single database (DB).

In addition, in order to open and view medical records contained in a CD, there is an inconvenience in that the CD should be loaded into and played back from a personal computer (PC) having a separate CD player.

Further, in the case of current medical records management systems, operators including doctors or nurses should gain access to a hospital application server via web-communication networks, for example, an internet communication network, and receive patient's medical records downloaded from the hospital application server, in order to query medical records of corresponding patients, but a downloading speed of the patient's medical records may be slow and there may be a security issue. In particular, these current medical records management systems are built to be hospital-centric and are mainly connected by medical staff. There may be a large number of technical, communications-related, and security-based problems until the current medical records management systems are built to be patient-centric. In particular, it may cause inconvenience that application servers of all the hospitals should be gathered and managed in one place in order that general users may easily gain access to desired application servers. Further, patients cannot store and manage their own medical records in their mobile phones in privacy.

In addition, it is difficult to obtain cooperation between many hospitals or medical institutions to share information countrywide or worldwide. Of course, there is still no legal and institutional basis for this cooperation. Further, an ultra-large central server, a high-speed communication network, and a security facility are required and therefore may be less likely to be implemented.

The related art includes Korean Patent No. 10-1135222 (Apr. 3, 2012), entitled “Method of managing multimedia files and a multimedia file producing apparatus,” Korean Patent Application Publication No. 10-2012-0084643 (Jul. 30, 2012), entitled “Method and apparatus for delivering multimedia messaging services utilizing smart terminal applications,” and Korean Patent Application Publication No. 10-2011-0084429 (Jul. 22, 2011), entitled “Method and system for connecting to imaging system service.”

### SUMMARY OF THE INVENTION

### Technical Problems

To solve the above conventional defects and disadvantages that manage patients' medical records, it is an object of the present invention to provide a method and apparatus for managing a client's medical records in a mobile terminal of the client, in which a concept of managing patients' medical records is changed from an existing hospital centric medical records management system to a patient centric medical records management system, and client's medical records, in particular, personal medical video images that are generated in hospitals are stored and displayed in and on the client's mobile terminal, to thus enable a patient or a patient's proxy to view the client's medical records displayed on the client's mobile terminal immediately when the client's medical records need to be viewed, and a transitory recording medium having a computer readable software program that executes the method of managing the client's medical records in the client's mobile terminal.

In addition, it is another object of the present invention to provide a method and apparatus for managing a client's medical records in a mobile terminal of the client, in which a central server such as a cloud server does not exist in order to manage patients' medical records, to thus save costs for purchasing and running the central server, costs for leasing dedicated lines, and costs for security management, and a transitory recording medium having a computer readable software program that executes the method of managing the client's medical records in the client's mobile terminal.

In addition, it is still another object of the present invention to provide a method and apparatus for managing a client's medical records in a mobile terminal of the client, in which the client's medical records generated in medical institutions or hospitals are stored only in the client's mobile terminal in order to manage the client's medical records, to thereby enhance security to prevent the third party from gaining access to the client's medical records illegally without due permission, and a transitory recording medium having a computer readable software program that executes the method of managing the client's medical records in the client's mobile terminal

In addition, it is yet another object of the present invention to provide a method and apparatus for managing a client's medical records in a mobile terminal of the client, in which client's medical records of various medical institutions or hospitals can be stored and managed for lifetime in a patient's client's mobile terminal, to thereby conveniently view the client's medical records immediately when the client's medical records need to be viewed, and to thus enhance quality of medical care, and a transitory recording medium having a computer readable software program that executes the method of managing the client's medical records in the client's mobile terminal

### Technical Solutions

According to one aspect of the present invention, there is provided a method of managing a client's medical records, which are stored in a personal computer (PC) of each of medical institutions or hospitals, the client's medical records generated in the medical institutions or hospitals being transmitted to a mobile terminal of the client, the method comprising:

in communications between the PC of each of the medical institutions or hospitals and the client's mobile terminal, receiving, by the PC, a client registration request from the client's mobile terminal, and registering client information including information about the client's mobile terminal, which is then stored and managed in a client information database (DB); and

compiling or converting the client's medical records in the PC, which are then transmitted to the client's mobile terminal, and storing and managing transmission information of the client's medical records in a transmission medical records DB,

wherein the client's medical records are managed by using a reader software program installed in the client's mobile terminal.

Preferably but not necessarily, if the reader software program is not installed in the client's mobile terminal, the PC transmits the reader software program to the client's mobile terminal in response to a request from the client's mobile terminal, so that the reader software program is installed in the client's mobile terminal.

According to another aspect of the present invention, there is provided a method of managing a client's medical records in a mobile terminal of the client, the client's mobile terminal receiving the client's medical records generated in medical institutions or hospitals, the method comprising:

in communications between a personal computer (PC) of each of the medical institutions or hospitals and the client's mobile terminal, requesting the PC for registration of the client's mobile terminal, to thus enable the PC to register client information including information about the client's mobile terminal;

receiving the client's medical records transmitted from the PC to the client's mobile terminal, and storing and managing the client's medical records in a reception medical records database (DB); and

searching the reception medical records DB and displaying the client's medical records on a display of the client's mobile terminal,

wherein the client's medical records are managed by using a reader software program installed in the client's mobile terminal.

Preferably but not necessarily, if the reader software program is not installed on the client's mobile terminal, the client's mobile terminal requests the PC to transmit the reader software program and receives the reader software program, so that the reader software program is installed on the client's mobile terminal.

According to another aspect of the present invention, there is provided an apparatus for managing a client's medical records, which are stored in a personal computer (PC) of each of the medical institutions or hospitals, the client's medical records generated in medical institutions or hospitals being transmitted to a mobile terminal of the client, the apparatus comprising:

in communications between the PC of each of the medical institutions or hospitals and the client's mobile terminal, a client information manager registering client information including information about the client's mobile terminal, which is then stored and managed in a client information database (DB), in response to a client registration request from the client's mobile terminal to the PC; and

a medical records manager compiling or converting the client's medical records in the PC, which are then transmitted to the client's mobile terminal, and storing and managing transmission information of the client's medical records in a transmission medical records DB,

wherein the client's medical records are managed by using a reader software program installed in the client's mobile terminal.

Preferably but not necessarily, if the reader software program is not installed in the client's mobile terminal, the apparatus further comprises a reader software program installer that enables the PC to transmit the reader software program to the client's mobile terminal in response to a request from the client's mobile terminal, so that the reader software program may be installed in the client's mobile terminal.

According to another aspect of the present invention, there is provided an apparatus for managing a client's medical records in a mobile terminal of the client, the client's mobile terminal receiving the client's medical records generated in medical institutions or hospitals, the apparatus comprising:

a reception medical records database (DB) that stores and manages the client's medical records received from a personal computer (PC) of each of the medical institutions or hospitals in communications between the PC and the client's mobile terminal; and

a reader software program operating unit that searches the reception medical records DB, displaying the reception medical records on a display of the client's mobile terminal.

Preferably but not necessarily, if the reader software program is not installed in the client's mobile terminal, the apparatus further comprises a reader software program installer that enables the PC to transmit the reader software program to the client's mobile terminal in response to a request from the client's mobile terminal, so that the reader software program may be installed in the client's mobile terminal.

According to another aspect of the present invention, there is provided a method of managing a client's medical records, the client's medical records generated in medical institutions or hospitals being transmitted to a mobile terminal of the client, the method comprising:

in communications between a personal computer (PC) of each of the medical institutions or hospitals and the client's mobile terminal, receiving, by the PC, a client registration request from the client's mobile terminal, and registering client information including information about the client's mobile terminal, which is then stored and managed in a client information database (DB); and

compiling or converting the client's medical records in the PC, which is then transmitted to the client's mobile terminal, and storing and managing transmission information of the client's medical records in a transmission medical records DB,

receiving the client's medical records transmitted from the PC to the client's mobile terminal, and storing and managing the client's medical records in a reception medical DB; and

searching the reception medical records DB and displaying the client's medical records on a display of the client's mobile terminal,

wherein the client's medical records are managed by using a reader software program installed in the client's mobile terminal.

Preferably but not necessarily, if the reader software program is not installed in the client's mobile terminal, the client's mobile terminal requests the PC to transmit the reader software program and receives the reader software program, so that the reader software program may be installed in the client's mobile terminal.

According to another aspect of the present invention, there is provided a transitory recording medium containing a software program for executing a method of managing a client's medical records in a personal computer (PC) of each of medical institutions or hospitals, the client's medical records generated in the medical institutions or hospitals being transmitted to a mobile terminal of the client, the method comprising:

in communications between the PC and the client's mobile terminal, receiving, by the PC, a client registration request from the client's mobile terminal, and registering client information including information about the client's mobile terminal, which is then stored and managed in a client information database (DB); and

compiling or converting the client's medical records in the PC, which is then transmitted to the client's mobile terminal, and storing and managing transmission information of the client's medical records in a transmission medical records DB,

wherein the client's medical records are managed by using a reader software program installed in the client's mobile terminal.

Preferably but not necessarily, if the reader software program is not installed in the client's mobile terminal, the PC transmits the reader software program to the client's mobile terminal in response to a request from the client's mobile terminal, so that the reader software program may be installed in the client's mobile terminal.

According to another aspect of the present invention, there is provided a transitory recording medium containing a software program for executing a method of managing a client's medical records in a mobile terminal of the client, the client's mobile terminal receiving the client's medical records generated in medical institutions or hospitals, the method comprising:

in communications between a personal computer (PC) of each of the medical institutions or hospitals and the client's mobile terminal, requesting the PC for registration of the client's mobile terminal, to thus enable the PC to register client information including information about the client's mobile terminal;

receiving the client's medical records transmitted from the PC to the client's mobile terminal, and storing and managing the client's medical records in a reception medical records database (DB); and

searching the reception medical records DB and displaying the client's medical records on a display of the client's mobile terminal,

wherein the client's medical records are managed by using a reader software program installed in the client's mobile terminal.

Preferably but not necessarily, if the reader software program is not installed in the client's mobile terminal, the client's mobile terminal requests the PC to transmit the reader software program and receives the reader software program, so that the reader software program may be installed in the client's mobile terminal.

According to another aspect of the present invention, there is provided a transitory recording medium containing a software program for executing a method of managing a client's medical records, the client's medical records generated in medical institutions or hospitals being transmitted to the client's mobile terminal, the method comprising:

in communications between a personal computer (PC) of each of the medical institutions or hospitals and a mobile terminal of the client, receiving, by the PC, a client registration request from the client's mobile terminal, and registering client information including information about the client's mobile terminal, which is then stored and managed in a client information database (DB); and

compiling or converting the client's medical records in the PC, which are then transmitted to the client's mobile terminal, and storing and managing transmission information of the client's medical records in a transmission medical records DB,

receiving the client's medical records transmitted from the PC to the client's mobile terminal, and storing and managing the client's medical records in a reception medical records DB; and

searching the reception medical records DB and displaying the client's medical records on a display of the client's mobile terminal,

wherein the client's medical records are managed by using a reader software program installed in the client's mobile terminal.

Preferably but not necessarily, if the reader software program is not installed in the client's mobile terminal, the client's mobile terminal requests the PC to transmit the reader software program and receives the reader software program, so that the reader software program may be installed in the client's mobile terminal.

### Advantageous Effects

As described above, a method and apparatus for managing a client's medical records in a mobile terminal of the client, according to the present invention, is configured to change a concept of managing patients' medical records from an existing hospital centric medical records management system to a patient centric medical records management system, in order to manage client's medical records, to include no central server such as a cloud server in order to manage patients' medical records, to thus save costs for purchasing and running the central server, costs for leasing dedicated lines, and costs for security management, to store the client's medical records generated in medical institutions or hospitals only in the client's mobile terminal in order to manage the client's medical records, to thereby enhance security to prevent the third party from gaining access to the client's medical records illegally without due permission, and to store and manage client's medical records of various medical institutions or hospitals for lifetime in a patient's client's mobile terminal, to thereby conveniently view the client's medical records immediately when the client's medical records need to be viewed, and to thus enhance quality of medical care.

### BRIEF DESCRIPTION OF THE DRAWINGS

FIG. 1 is a schematic block diagram for explaining operation of an apparatus for managing a client's medical records according to the present invention.

FIG. 2 is a view schematically illustrating a display on which a reader software program operates for registering client information and information about a client's mobile terminal, to which the present invention is applied, on a personal computer (PC) at a medical institution or hospital.

FIG. 3 is a view schematically illustrating a display on which a writer software program operates for managing client information and information about a client's mobile terminal in a PC of each of medical institutions or hospitals to which the present invention is applied.

FIG. 4 is a view schematically illustrating a display on which a writer software program operates for transmitting and managing a client's medical records in a PC of each of medical institutions or hospitals to which the present invention is applied.

FIG. 5 is a view schematically illustrating a display on which a reader software program operates for receiving and managing a client's medical records in a client's mobile terminal to which the present invention is applied.

FIG. 6 is a schematic flowchart view for explaining a method of managing client's medical records in a mobile terminal of the client, according to the present invention.

### BEST MODE FOE CARRYING OUT THE INVENTION

Hereinafter, the structure and operation of a method and apparatus for managing a client's medical records in a mobile terminal of the client, according to an embodiment of the present invention, will be described in detail with reference to the accompanying drawings.

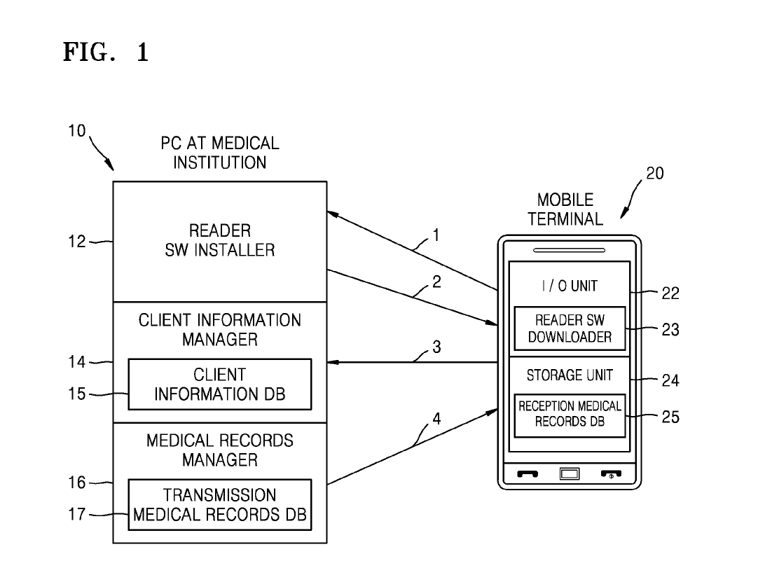

FIG. 1 is a schematic block diagram for explaining operation of an apparatus for managing a client's medical records according to the present invention.

Referring to FIG. 1, the apparatus for managing the client's medical records according to the present invention is implemented as a personal computer (PC) 10 at a medical institution or hospital side, and is implemented as a mobile terminal 20 at a client or patient side. That is, the PC 10 that is disposed at a medical institution or hospital side is a medical records transmitting device, and the client's mobile terminal 20 is a medical records receiving device. A medical records writer software program is installed in the PC 10, and a medical records reader software program is installed in the client's mobile terminal 20.

In FIG. 1, the apparatus for managing the client's medical records in a PC 10 of each of the medical institutions or hospitals is illustrated, in which the client's medical records generated in medical institutions or hospitals are transmitted to the client's mobile terminal 20 from the PC 10 of each of the medical institutions or hospitals. The client's medical records managing apparatus at a medical institution or hospital side, includes: according to communications between the PC 10 of each of the medical institutions or hospitals and the client's mobile terminal 20, a client information manager 14 registering client's information including client's mobile terminal information to then be stored and managed in a client's information database (DB) 15, by a client registration request transferred from the client's mobile terminal 20 to the PC 10; and a medical records manager 16 compiling or converting the client's medical records in the PC 10, to then be transmitted to the client's mobile terminal 20, and storing and managing transmission information of the client's medical records in a transmission medical records DB 17, wherein the client's medical records are managed by using a reader software program installed in the client's mobile terminal 20.

Meanwhile, in the case that the reader software program is not installed in the client's mobile terminal 20, the client's medical records managing apparatus further comprises a reader software program installer 12 that enables the PC 10 to transmit the reader software program to the client's mobile terminal 20 by a request from the client's mobile terminal 20, so that the reader software program is installed in the client's mobile terminal 20.

In addition, the apparatus for managing client's medical records in a client's mobile terminal 20, is illustrated in FIG. 1, in which the client's mobile terminal 20 receives the client's medical records generated in medical institutions or hospitals. The client's medical records managing apparatus at a client or patient side, includes: a reception medical records DB 25 that stores and manages the client's medical records received from a PC 10 of each of the medical institutions or hospitals according to communications between the PC 10 and the client's mobile terminal 20; and a reader software program operating unit that searches the reception medical records DB 25 and displays the client's medical records on a display of the client's mobile terminal 10. Here, the reader unit, i.e., the reader software program operating unit, is a processor for executing the reader software program that is installed and executed in the mobile terminal. However, since such a processor is substantially the same as the conventional central processing unit (CPU), in view of the structure and operation, the detailed description thereof will be omitted.

Although not shown in FIG. 1, a variety of kinds of wireless communication methods can be applied between the PC 10 at a medical institution or hospital side and the client's mobile terminal 20 at a client or patient side. In this embodiment, a web communication method is applied between the PC 10 and the client's mobile terminal 20. The PC 10 plays a role of a web server corresponding to an application server providing an application to the client's mobile terminal, in which a writer software program is installed and executed in the PC 10. In addition, the client's mobile terminal 20 plays a role of a web client, in which a reader or viewer software program corresponding to an application is downloaded from the web server into the client's mobile terminal 20, and installed and executed in the client's mobile terminal 20.

Referring back to FIG. 1, in the case that the reader software program is not installed in the client's mobile terminal 20, the PC 10 is accessed through an input/output (I/O) portion of the client's mobile terminal 20 according to a wireless communication method (operation 1), and thus the reader software program is downloaded from the reader software program installer 12 of the PC 10 to a reader software program downloader 23 of the client's mobile terminal 20 (operation 2).

Then, to download client's medical records from the PC 10 at a medical institution or hospital to the client's mobile terminal 20, client's information and client's mobile terminal information should be registered in the PC 10 (operation 3). That is, client's information and client's mobile terminal information is registered in the client information manager 14 of the PC 10, and is stored and managed in the client information database (DB) 15 (operation 3).

After client's information and client's mobile terminal information is registered in the client information manager 14 of the PC 10, the medical records manager 16 of the PC 10 compiles or converts the client's medical records registered in the PC 10, to then be transmitted to the client's mobile terminal 20, and to then store and manage transmission information of the client's medical records in the transmission medical records database (DB) 17 (operation 4). In other words, when the client's medical records are transmitted from the PC 10 to the client's mobile terminal 20, the client's medical records are stored in a storage unit 24 of the client's mobile terminal 20, and the reception information of the client's medical records is stored and managed in the reception medical records database (DB) 25.

As described above, the apparatus for managing client's medical records according to the present invention is implemented as a personal computer (PC) 10 at a medical institution or hospital side, and is implemented as a mobile terminal 20 at a client or patient side. An editor software program (SW) that compiles media data such as texts, images, and videos containing medical records, or converts the media data into graphical data such as DICOM (Digital Image Communication in Medicine), pdf, jpg, tiff, or mpeg, to then transmit the compiled or converted result to the mobile terminal 20 that is capable of wireless web communications such as WiFi, and to thus manage the client's information, the client's mobile terminal information, and the medical records, is installed in the PC 10 in order to manage the client's medical records. For convenience of explanation, the editor software program (SW) is called a writer software program (SW). In the case that medical records compiled in the writer software program (SW) are formed in a DICOM, pdf, jpg, tiff, or mpeg format, such medical records are transmitted without a separate conversion process.

The writer software program (SW) that is installed in the personal computer (PC) 10 at a medical institution or hospital side, acquires medical records such as images made up in the DICOM (Digital Image Communication in Medicine) standard, medical records such as videos made up in the DICOM or MPEG (Moving Picture Expert Group) standard, and medical records such as texts in the general text standard, and then compiles or converts the acquired medical records to then be transmitted to the client's mobile terminal as described above. In addition, the writer software program (SW) that is installed in the PC 10 at a medical institution or hospital side is provided to install the reader software program (SW) on the client's mobile terminal 20, and to encrypt, store, and manage the transmitted medical records in a DB. In addition, the writer SW plays a role of performing authentication when the client's mobile terminal 20 gains access to the PC 10 via the reader SW installed in the client's mobile terminal.

In other words, the writer SW installed in the PC 10 at a medical institution or hospital side performs three functions of: a client's information DB including an approval of a registration request of a client's mobile terminal and a registration of a client's mobile terminal; a transmission medical records DB including compiling or converting corresponding client's medical records and transmitting the compiled or converted medical records to the registered client's mobile terminal, and storing and managing the transmitted medical records information; and an installation of a reader SW on a client's mobile terminal. Although it is not described here, a technical function of making the PC 10 store/query/retrieve/fetch, for example, DICOM-formatted medical records such as texts, images or videos from a medical records DB controlled by a data server (not shown), can be implemented by employing a known standard technology such as DICOM, and thus the description thereof will be omitted.

The above-described communication method, data conversion method, encryption method, and authentication technologies may be applied in a variety of well-known schemes, and it may not be helpful in understanding the subject matter of the present invention. Therefore, the detailed description thereof will be omitted.

Meanwhile, a viewer or reader SW is downloaded from a PC to a client's mobile terminal, and installed in the client's mobile terminal. Accordingly, the client's mobile terminal can receive corresponding client's medical records from the PC and can make the corresponding client's medical records opened and viewed on a display of the client's mobile terminal, through the viewer or reader SW. The viewer or reader SW may suffice with an only one-time installation, and thereafter upgrading of the viewer or reader SW can be automatically or manually reinstalled wirelessly or by wire. The viewer or reader SW installed in the client's mobile terminal plays a role of storing, managing, searching, displaying, retrieving, and querying client's medical records received from the PC in a medical institution or hospital through the writer SW.

Referring back to FIG. 1, according to an aspect of the present invention, the method for managing client's medical records in a PC 10 of each of the medical institutions or hospitals will be described below, in which the client's medical records generated in medical institutions or hospitals are transmitted to a client's mobile terminal 20 from the PC 10 of each of the medical institutions or hospitals.

In FIG. 1, the client's medical records managing method at a medical institution or hospital side, includes: according to communications between the PC 10 of each of the medical institutions or hospitals and the client's mobile terminal 20, receiving a client registration request transferred from the client's mobile terminal 20 in the PC 10, and registering client's information including client's mobile terminal information to then be stored and managed in a client's information DB 15; and compiling or converting the client's medical records in the PC 10, to then be transmitted to the client's mobile terminal 20, and storing and managing transmission information of the client's medical records in a transmission medical records DB 17, wherein the client's medical records are managed by using a reader software program installed in the client's mobile terminal 20.

Meanwhile, in the case that the reader software program is not installed in the client's mobile terminal 20, the client's medical records managing method further includes installing a reader SW in the client's mobile terminal 20, which enables the PC 10 to transmit the reader software program to the client's mobile terminal 20 by a request from the client's mobile terminal 20, so that the reader software program is installed in the client's mobile terminal 20.

Referring back to FIG. 1, according to another aspect of the present invention, the method of managing client's medical records in a client's mobile terminal, will be described below, in which the client's mobile terminal receives the client's medical records generated in medical institutions or hospitals.

In FIG. 1, the client's medical records managing method in a client's mobile terminal 20 includes: according to communications between a PC 10 of each of the medical institutions or hospitals and the client's mobile terminal 20, requesting for client's registration of the client's mobile terminal 20 to the PC 10, to thus enable the PC 10 to register client's information including client's mobile terminal information; receiving the client's medical records transmitted from the PC 10 to the client's mobile terminal 20, and storing and managing the client's medical records in a reception medical records DB 25; and searching the reception medical records DB 25 of the client's mobile terminal 20, and displaying the stored client's medical records on a display of the client's mobile terminal 20, wherein the client's medical records are managed by using a reader software program installed in the client's mobile terminal 20.

Meanwhile, in the case that the reader software program is not installed in the client's mobile terminal 20, the client's medical records managing method further includes installing a reader software program the client's mobile terminal 20, in which the client's mobile terminal requests the PC 10 to transmit the reader software program and receives the reader software program from the PC 10, so that the reader software program is installed in the client's mobile terminal 20.

Hereinafter, the operation of the client's medical records managing method and apparatus will be described in detail with reference to the accompanying drawings.

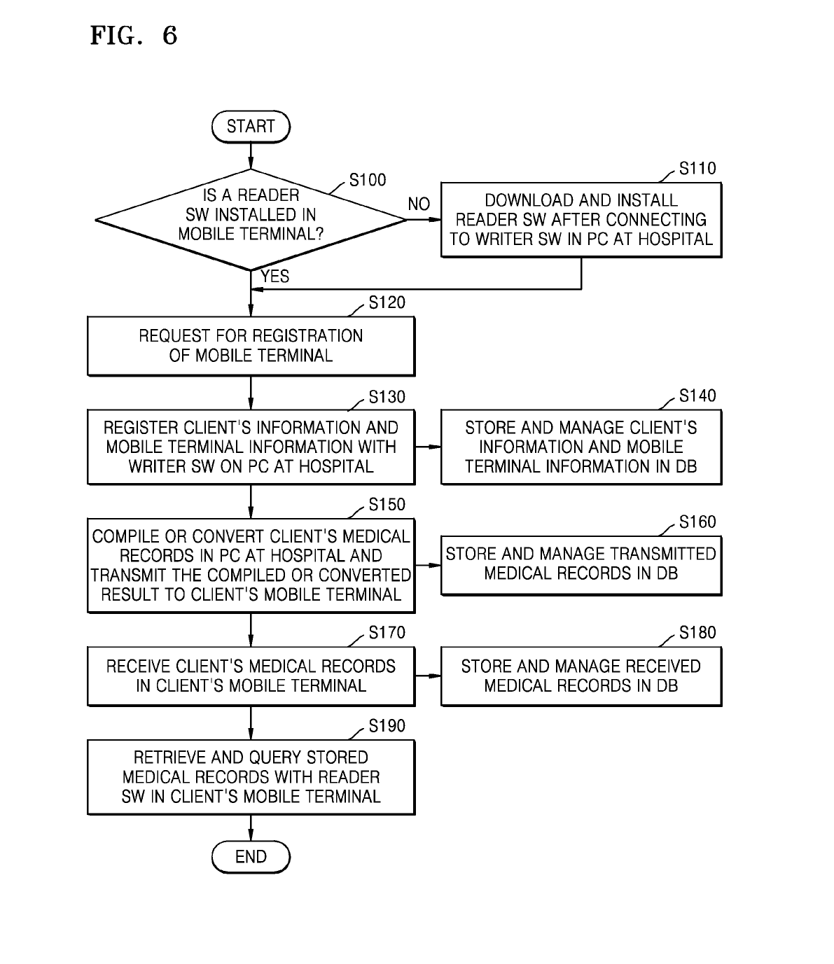

FIG. 6 is a schematic flowchart view for explaining a method of managing client's medical records in a client's mobile terminal 20 according to the present invention.

Referring to FIGS. 1 and 6, if it is judged that a reader software program (SW) is installed in a client's mobile terminal 20 in operation S100, the program proceeds to operation S120, and if not, a reader SW is downloaded from the PC 10 at a medical institution or hospital side and installed in the client's mobile terminal 20. A writer SW is installed in the PC 10, and thus enables the client's mobile terminal 20 to download the reader SW from the PC 10. If it is judged that a reader SW is not installed in a client's mobile terminal 20 in operation S100, a client or a patient gains access to an internet protocol (IP) address of the PC 10 or a designated application server, via the internet communications, or by scanning a bar code or a quick response (Q/R) code, through the client's mobile terminal 20, and then the reader SW is downloaded automatically or manually from the PC 10 to the client's mobile terminal 20. Once the reader SW is downloaded, the reader SW is automatically installed in the client's mobile terminal 20 upon an agreement on installation. Since the reader SW is downloaded and installed in the same method as a general application called an app, the detailed description thereof will be omitted.

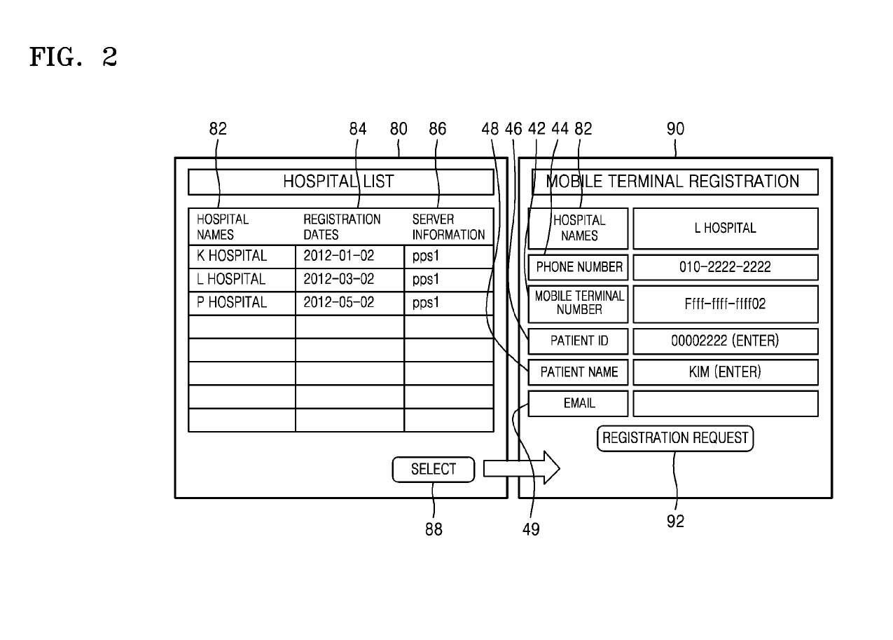

A request for registration of the client's mobile terminal 20 is transferred to the PC 10 in operation S120. The registration request process will be described below with reference to FIG. 2.

FIG. 2 is a view schematically illustrating a display on which a reader SW operates for registering client's information and client's mobile terminal information in a client's mobile terminal 20 to which the present invention is applied, on a PC 10 at a medical institution or hospital.

Referring to FIGS. 1 and 2, when a request for registration of client's information and client's mobile terminal information is transferred to the PC 10 from the client's mobile terminal 20, a hospital list screen 80 is displayed on the client's mobile terminal 20. The hospital list screen 80 includes hospital names 82, registration dates 84, and server information 86. If a client or patient selects one of the hospital names 82 and presses a select button 88 in the client's mobile terminal 20, the hospital list screen 80 is changed to a mobile terminal registration screen 90. On the mobile terminal registration screen 90, the client or patient confirms the hospital name 82, enters a telephone number 44, a mobile terminal unique number 42, a patient's ID 46, a patient's name 48, and an e-mail 49, and presses a registration request button 92, to thus request for registration of client's information and client's mobile terminal information to the PC 10.

Referring back to FIG. 6, if a registration of the mobile terminal is requested in operation S120 and the registration request button 92 is pressed, the client's information and client's mobile terminal information is registered in operation S130 by the writer SW installed in the PC 10 in the selected medical institution or hospital. Then, the client's information and client's mobile terminal information is stored and managed through a DB in operation S140.

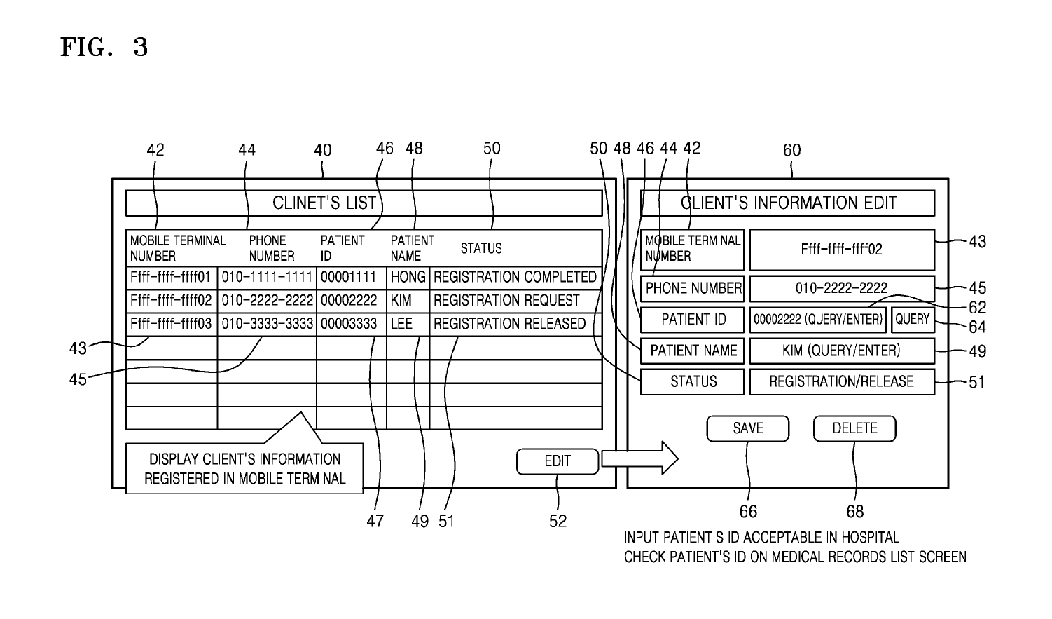

FIG. 3 is a view schematically illustrating a display on which a writer software program operates for managing client's information and client's mobile terminal information in a PC 10 of each of medical institutions or hospitals to which the present invention is applied.

As shown in FIG. 3, the PC 10 at a corresponding medical institution or hospital enables the writer SW to operate and fetch a client's list containing client's information and client's mobile terminal information registered by the mobile terminal 20, from a DB containing the client's information and client's mobile terminal information to then be displayed on a client's list display screen 40. Client's mobile terminal serial numbers 42, client's phone numbers 44, patient's IDs 46, patient's names 48, and registration status 50, are included on the client's list display screen 40. The client's mobile terminal serial numbers 42 may be displayed in the form of Ffff-ffff-ffff0X 43, for example, but are not limited thereto. The client's phone numbers 44 may be displayed in the form of 010-xxxx-xxxx 45 as actual client's phone numbers. The patient's IDs 46 become client's IDs 47 registered by clients. The patient's names 48 are patient's real names 49. The registration status 50 may display whether a registration has been completed, has been requested but not yet registered, and had been approved but now released.

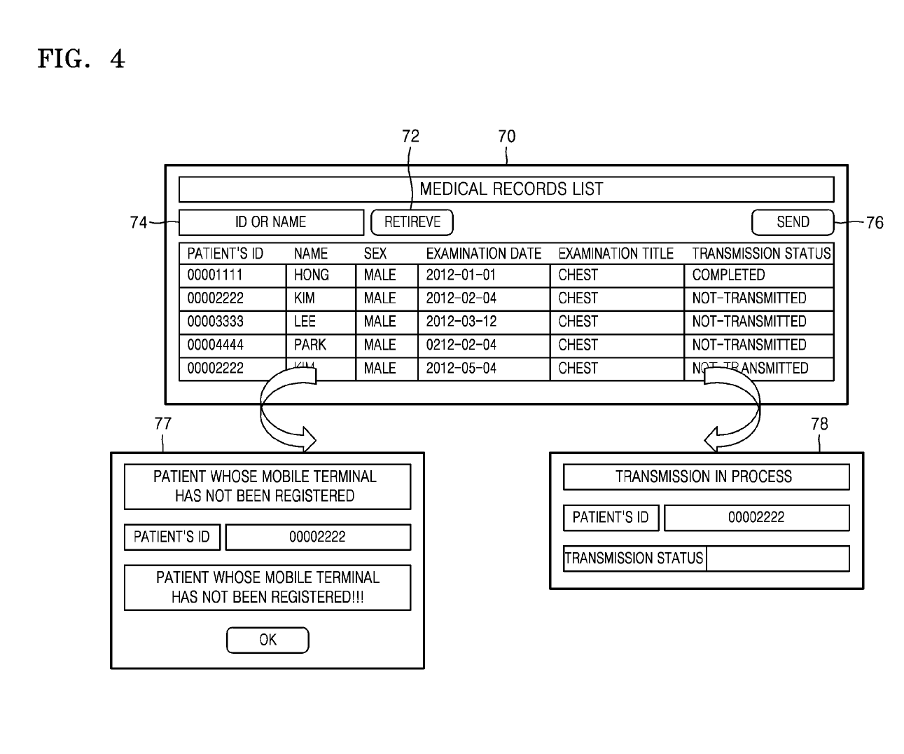

Meanwhile, if a registration request 51 is selected and then an edit button 52 is pressed on the client's list display screen 40, the client's list display screen 40 is changed into a client's information editing screen 60. On the client's information editing screen 60, the client confirms Ffff-ffff-ffff02 43 at the client's mobile terminal serial numbers 42, and 010-2222-2222 45 at the client's phone numbers 44, presses an input button 62 and enters a patient's ID at the patient's IDs 46 or presses an inquiry button 64 to inquire the patient's ID, inputs a patient's name at the patient's names 48 or confirms an inquired patient's name 49, and confirms a registration/release status 51 at a status 50, to then press a save button 66 to store the client's information or press a cancel button 68 to cancel the client's information. In this case, the patient's ID should be saved in the PC 10 at the corresponding medical institution or hospital, and the patient's ID should be checked on a medical records list screen 70 of FIG. 4. The client's information, patient IDs, patient's names, etc. are entered through the client's mobile terminal 20 and then requested to be registered in the PC 10 at a medical institution or hospital. However, if an input error happens, incorrect data may be registered. Accordingly, operators at medical institutions or hospitals should confirm and edit patient's IDs and patient's names. If patient's IDs and patient's names need not be edited, the operation proceeds to the next operation.

Referring back to FIG. 6, the client's information and the client's mobile terminal information is registered in operation S130, and then the PC 10 compiles or converts the registered client's medical records and transmits the compiled or converted results to the registered client's mobile terminal 20, according to a client's medical records transmission request or without receiving such a client's medical records transmission request, in operation S140. As described above, the PC 10 compiles media data such as texts, images, and videos containing the client's medical records from a separate storage or data center, or converts the compiled data into graphic data such as DICOM, pdf, jpg, tiff, or mpeg if the compiled media data is not suitable for transmission, to thus transmit the media data containing the client's medical records to the client's mobile terminal 20 capable of performing web communications.

FIG. 4 is a view schematically illustrating a display on which a writer SW operates for transmitting and managing client's medical records in a PC 10 of each of medical institutions or hospitals to which the present invention is applied.

Referring to FIG. 4, the PC 10 at a corresponding medical institution or hospital recalls a medical records list screen 70 to enable a client to enter a client's ID or name 74 on the medical records list screen 70, to press a retrieve button 72 to retrieve the client's ID or name 74, and to press a send button 76 to transmit medical records of the retrieved client to the registered client's mobile terminal 20 in operation S140. Here, in the case that it is judged that the client's mobile terminal on the retrieved client's medical records list screen 70 is not registered, a screen 77 to display that the client's mobile terminal has been unregistered thereon is displayed to thus induce the client to step on a registration process of a client's mobile terminal. The reason of displaying that the client's mobile terminal has been unregistered on the screen 77 is that a number of patients request for registration simultaneously on the PC 10 to download their medical records. In other words, a number of patients are simultaneously managed on the client's medical records list screen 70. In the case of a client whose mobile terminal has been registered, a medical records transmission process display screen 78 is displayed on the registered client's mobile terminal 20. In this case, a transmission process may be displayed. The medical records are automatically transmitted to the registered client's mobile terminal 20, that is, the compiled client's medical records are automatically downloaded to the registered client's mobile terminal 20. Once the download of the compiled client's medical records is completed, the PC 10 at a corresponding medical institution or hospital changes the registration status into the registration release, to thereby stop the medical records from being further downloaded.

Referring back to FIG. 6, the client's medical records are transmitted in operation S150, and the medical records transmission history is stored and managed as transmission information in a transmission medical records DB in operation S160.

Then, the client's medical records sent by the PC 10 at a corresponding medical institution or hospital are received and stored by the client's mobile terminal 20 in operation S170, and the medical records reception history is stored and managed as reception information in a reception medical records DB in operation S180.

Thereafter, the client's medical records received from the personal computer (PC) 10 at a corresponding medical institution or hospital can be searched, retrieved and queried through a reader SW in the client's mobile terminal 20 in operation S190.

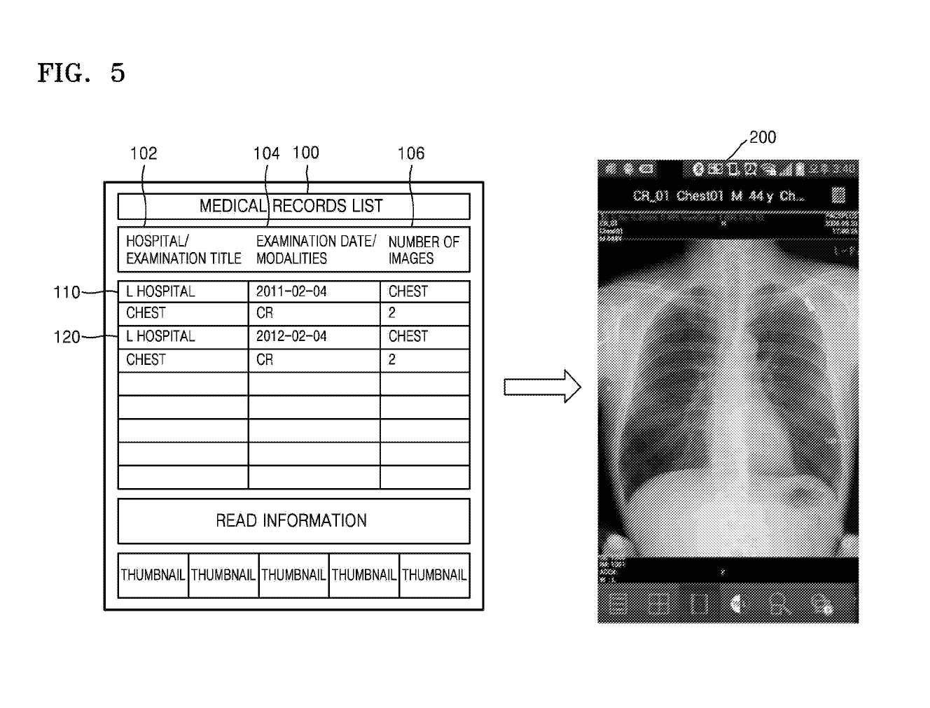

FIG. 5 is a view schematically illustrating a display on which a reader software program operates for receiving and managing including storing, searching, displaying, retrieving, and querying client's medical records in a client's mobile terminal 20 to which the present invention is applied.

Referring to FIG. 5, a medical records list screen 100 is displayed on the client's mobile terminal 20, and hospital names/examination titles 102, examination dates/modalities 104, and media data numbers such as the numbers of texts, images, videos 106 are displayed on the medical records list screen 100. If one of the items 110 and 120 on the medical records list screen 100 is selected, a corresponding medical record or medical data is displayed on a medical records display screen 200. For example, a current lesion of chest CR 120 can be compared to the prior lesion of chest CR 110 taken 1 year ago. If there is no remarkable change in the size and shape of the lesion since 1 year, the lesion may be a benign lesion. But if the lesion becomes bigger and lobulated remarkably, the lesion may be a malignant lesion, which will require further special examinations for the diagnosis. The reader SW provides a comparable measurement function between lesions, that is, the regions of the interest.

As described above, a method and apparatus for managing client's medical records in a client's mobile terminal according to the present invention enables a patient to contain and carry his or her medical records conveniently in his or her mobile terminal such as a smart phone, in view of the patient. General mobile terminals have sufficient storage capacities to thus enable lifetime medical records to be stored therein. Since the medical records are stored and managed together with the information of examination dates in the reception medical records DB of the mobile phone, the lesion of the current image can be compared to the lesions of the prior images in terms of the size and the shape of the lesion. That is, the patient or his/her doctor can conveniently follow up the progress of the lesion or the disease. In addition, since a patient or patient agent manages his or her own medical records, no security problems will occur. The important thing is that burdens of medical institutions or hospitals such as tremendous costs for operation of a central cloud server, high-speed communication costs, and security issues, will be solved all at a time.

The method and apparatus for managing client's medical records in a client's mobile terminal according to the present invention can be applied to PCs 10 at medical institutions or hospitals, to thereby enable medical records to be transmitted, stored, and managed in client's mobile terminals, respectively, and to thus significantly eliminate costs for storing and managing medical records in order to provide clients with compact discs (CDs) containing client's medical records at each of the medical institutions or hospitals. In other words, a writer SW for performing the client's medical records managing method is installed in a PC 10 at a medical institution or hospital side, and a reader SW for performing the client's medical records managing method is downloaded from a PC 10 at a medical institution or hospital side, and installed in a client's mobile terminal. It is difficult to gain access to each of the medical institutions or hospitals in common to retrieve and query medical records since image or video formats, media schemes, and communications schemes differ in each of the medical institutions or hospitals, but the method and apparatus for managing client's medical records according to the present invention enables clients or patients to store, search, display, retrieve, query or manage their own medical records more easily in their respective mobile terminals, and further enables the other medical institutions or hospitals to perform medical care on the basis of past medical records to thereby provide an advantage of improving quality of medical care.

In addition, the mobile terminals applied in the present invention may be smart phones, personal digital assistants (PDAs), notebook computers, or note pads that are all capable of performing internet communications.

In addition, although it has not been described above, the method and apparatus for managing client's medical records in a client's mobile terminal according to the present invention enables the client's mobile terminal to be connected to a TV or PC monitor to thereby display the client's medical records on a larger-sized screen than the client's mobile terminal such as a smart phone. Further, it is of course that medical records stored in a mobile terminal can be transmitted to a PC at a medical institution or hospital side.

Medical records applicable in the present invention are texts such as alphanumeric data, video data and/or audio data, as well as image data such as CT, MRI, X-ray, or ultrasound data of patients.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

A method and apparatus for managing client's medical records according to the present invention is applied for a PC at a medical institution or hospital side and a client's mobile terminal such as a smart phone, to thereby expect to improve quality of medical services.

1. A method of managing a client's medical records, which are stored in a personal computer (PC) of each of medical institutions or hospitals, the client's medical records generated in the medical institutions or hospitals being transmitted to a mobile terminal of the client, the method comprising:
in communications between the PC of each of the medical institutions or hospitals and the client's mobile terminal, receiving, by the PC, a client registration request from the client's mobile terminal, and registering client information including information about the client's mobile terminal, which client information is then stored and managed in a client information database (DB); and
compiling or converting the client's medical records in the PC, which compiled or converted medical records are then transmitted to the client's mobile terminal, and storing and managing transmission information of the client's medical records in a transmission medical records DB,
wherein the client's medical records are managed by using a reader software program installed in the client's mobile terminal.

2. The method of claim 1, wherein, if the reader software program is not installed in the client's mobile terminal, the PC transmits the reader software program to the client's mobile terminal in response to a request from the client's mobile terminal, so that the reader software program is installed in the client's mobile terminal.

3. A method of managing a client's medical records in a mobile terminal of the client, the client's mobile terminal receiving the client's medical records generated in medical institutions or hospitals, the method comprising:
in communications between a personal computer (PC) of each of the medical institutions or hospitals and the client's mobile terminal, requesting the PC for registration of the client's mobile terminal, to thus enable the PC to register client information including information about the client's mobile terminal;
receiving the client's medical records transmitted from the PC to the client's mobile terminal and then storing and managing the client's medical records in a reception medical records database (DB); and
searching the reception medical records DB and displaying the client's medical records on a display of the client's mobile terminal,
wherein the client's medical records are managed by using a reader software program installed in the client's mobile terminal.

4. The method of claim 3, wherein, in the case that the reader software program is not installed in the client's mobile terminal, the client's mobile terminal requests the PC to transmit the reader software program and receives the reader software program, so that the reader software program is installed in the client's mobile terminal.

5. An apparatus for managing a client's medical records, which are stored in a personal computer (PC) of each of the medical institutions or hospitals, the client's medical records generated in medical institutions or hospitals being transmitted to a mobile terminal of the client, the apparatus comprising:
in communications between the PC of each of the medical institutions or hospitals and the client's mobile terminal, a client information manager registering client information including information about the client's mobile terminal, which client information is then stored and managed in a client information database (DB), in response to a client registration request from the client's mobile terminal to the PC; and
a medical records manager compiling or converting the client's medical records in the PC, which compiled or converted medical records are then transmitted to the client's mobile terminal, and storing and managing transmission information of the client's medical records in a transmission medical records DB,
wherein the client's medical records are managed by using a reader software program installed in the client's mobile terminal.

6. The apparatus of claim 5, wherein, if the reader software program is not installed in the client's mobile terminal, the apparatus further comprises a reader software program installer that enables the PC to transmit the reader software program to the client's mobile terminal in response to a request from the client's mobile terminal, so that the reader software program may be installed in the client's mobile terminal.

7. An apparatus for managing a client's medical records in a mobile terminal of the client, the client's mobile terminal receiving the client's medical records generated in medical institutions or hospitals, the apparatus comprising:
a reception medical records database (DB) that stores and manages the client's medical records received from a personal computer (PC) of each of the medical institutions or hospitals in communications between the PC and the client's mobile terminal; and
a reader software program operating unit that searches the reception medical records DB, and then display the client's medical records on a display of the client's mobile terminal.

8. The apparatus of claim 7, wherein, if the reader software program is not installed in the client's mobile terminal, the apparatus further comprises a reader software program installer that enables the PC to transmit the reader software program to the client's mobile terminal in response to a request from the client's mobile terminal, so that the reader software program may be installed in the client's mobile terminal.

9. A method of managing a client's medical records, the client's medical records generated in medical institutions or hospitals being transmitted to a mobile terminal of the client, the method comprising:
in communications between a personal computer (PC) of each of the medical institutions or hospitals and the client's mobile terminal, receiving, by the PC, a client registration request from the client's mobile terminal, and registering client information including information about the client's mobile terminal, which client information is then stored and managed in a client information database (DB); and
compiling or converting the client's medical records in the PC, which compiled or converted medical records are then transmitted to the client's mobile terminal, and storing and managing transmission information of the client's medical records in a transmission medical records DB,
receiving the client's medical records transmitted from the PC to the client's mobile terminal, and storing and managing the client's medical records in a reception medical DB; and
searching the reception medical records DB, and then displaying the client's medical records on a display of the client's mobile terminal,
wherein the client's medical records are managed by using a reader software program installed in the client's mobile terminal.

10. The method of claim 9, wherein, if the reader software program is not installed in the client's mobile terminal, the client's mobile terminal requests the PC to transmit the reader software program and receives the reader software program, so that the reader software program may be installed in the client's mobile terminal.

11. A transitory recording medium containing a software program for executing a method of managing a client's medical records in a personal computer (PC) of each of medical institutions or hospitals, the client's medical records generated in the medical institutions or hospitals being transmitted to a mobile terminal of the client, the method comprising:
in communications between the PC and the client's mobile terminal, receiving, by the PC, a client registration request from the client's mobile terminal, and registering client information including information about the client's mobile terminal, which client information is then stored and managed in a client information database (DB); and
compiling or converting the client's medical records in the PC, which compiled or converted medical records are then transmitted to the client's mobile terminal, and storing and managing transmission information of the client's medical records in a transmission medical records DB,
wherein the client's medical records are managed by using a reader software program installed in the client's mobile terminal.

12. The transitory recording medium of claim 11, wherein, if the reader software program is not installed in the client's mobile terminal, the personal computer (PC) transmits the reader software program to the client's mobile terminal in response to a request from the client's mobile terminal, so that the reader software program may be installed in the client's mobile terminal.

13. A transitory recording medium containing a software program for executing a method of managing a client's medical records in a mobile terminal of the client, the client's mobile terminal receiving the client's medical records generated in medical institutions or hospitals, the method comprising:
in communications between a personal computer (PC) of each of the medical institutions or hospitals and the client's mobile terminal, requesting the PC for registration of the client's mobile terminal, to thus enable the PC to register client information including information about the client's mobile terminal;
receiving the client's medical records transmitted from the PC to the client's mobile terminal, and storing and managing the client's medical records in a reception medical records database (DB); and
searching the reception medical records DB, and then displaying the client's medical records on a display of the client's mobile terminal,
wherein the client's medical records are managed by using a reader software program installed in the client's mobile terminal.

14. The transitory recording medium of claim 13, wherein, if the reader software program is not installed in the client's mobile terminal, the client's mobile terminal requests the PC to transmit the reader software program and receives the reader software program, so that the reader software program may be installed in the client's mobile terminal.

15. A transitory recording medium containing a software program for executing a method of managing a client's medical records, the client's medical records generated in medical institutions or hospitals being transmitted to the client's mobile terminal, the method comprising:
in communications between a personal computer (PC) of each of the medical institutions or hospitals and a mobile terminal of the client, receiving, by the PC, a client registration request from the client's mobile terminal, and registering client information including information about the client's mobile terminal, which client information is then stored and managed in a client information database (DB); and
compiling or converting the client's medical records in the PC, which compiled or converted medical records are then transmitted to the client's mobile terminal, and storing and managing transmission information of the client's medical records in a transmission medical records DB,
receiving the client's medical records transmitted from the PC to the client's mobile terminal, and storing and managing the client's medical records in a reception medical records DB; and
searching the reception medical records DB, and then displaying the client's medical records on a display of the client's mobile terminal,
wherein the client's medical records are managed by using a reader software program installed in the client's mobile terminal.

16. The transitory recording medium of claim 15, wherein, if the reader software program is not installed in the client's mobile terminal, the client's mobile terminal requests the PC to transmit the reader software program and receives the reader software program, so that the reader software program may be installed in the client's mobile terminal.
